(19) United States
(12) Patent Application Publication
(10) Pub. No.: US 2005/0236323 A1
(43) Pub. Date: Oct. 27, 2005

(54) Water filter for hot beverage brew baskets

(76) Inventors: John Oliver, Boca Raton, FL (US); Alejandro Pena, Boca Raton, FL (US)

Correspondence Address: Lawrence J. Shurupoff;Sunbeam Products, Inc., 2381 Executive Center Drive, Boca Raton, FL, 33431, US

(21) Appl. No.: 10/833,530

(22) Filed: Apr. 27, 2004

(51) Int. Cl. B01D 29/05

(52) U.S. Cl. 210/464; 210/473; 210/477

(57) ABSTRACT

A filter assembly for a brew basket includes a filter, a filter holder to removeably hold the filter, one or more support tabs extending outwardly from the periphery of the filter holder to an extent effective in engaging the brew basket so as to suspend the filter holder no higher than substantially flush with an upper rim of the brew basket. The support tabs are of sufficient dimension and under substantially no bending stress when the filter holder is suspended in the brew basket so as to demonstrate no substantial deformation under normal heat conditions within the brew basket during use.

### BACKGROUND OF THE DISCLOSURE

1. Field of the Disclosure

The present invention relates to water filters for brew baskets, such as used in coffee makers.

2. Description of the Related Art

Various devices have been devised to provide water filters for coffeemakers, many of them complicated and costly. A filter described in Koslow et al., U.S. Patent Publication No. US2001/0032882 A1, entitled DEVICE, METHOD, AND SYSTEM FOR REMOVING CONTAMINANTS FROM A LIQUID, published Oct. 25, 2001, is schematically shown in FIG. 1. The device has a filter contained in a circular filter holder 1 that is rimmed with a plurality of flexible thermoplastic supporting tabs 2. The device is pushed down into a generally conical brew basket 3 until the supporting tabs 2 resiliently bend against the interior surface of the brew basket 3 and thereby support the filter.

A potential problem with prior plastic framed filters device is that thermoplastics tend to soften and lose their resiliency when subjected to heat and stress, particularly polyethylene. The result is that the filter may drop onto the coffee grounds or even tip over, resulting in a spill-over and allowing unfiltered water to reach the coffee grounds. The present invention has been developed to overcome these drawbacks.

### BRIEF SUMMARY OF THE DISCLOSURE

The present invention is directed to a filter assembly for a brew basket having a filter, a filter holder to removeably hold the filter, one or more support tabs extending outwardly from the periphery of the filter holder to an extent effective to engage the brew basket so as to suspend the filter holder no higher than substantially flush with an upper rim of the brew basket. One or more support tabs are of sufficient dimension and under substantially no bending stress when the filter holder is suspended in the brew basket so as to demonstrate no substantial deformation, under normal heat conditions, within the brew basket during use. That is, the support tabs are only subjected to the weight of the filter and filter holder and are not deformed or otherwise loaded during use, other than by the passage of water.

In another aspect of the invention, the support tabs rest upon an upper rim of the brew basket.

In another aspect of the invention, each support tab engages a tab receiver located on an inner wall of the brew basket. Each support tab may nest within a tab receiving pocket formed on the brew basket.

In another aspect of the invention, the filter holder is hinged to the brew basket.

In another aspect of the invention, the filter is affixed to the filter holder by a plurality of snap-on mounting units, each snap-on mounting unit having a support tab thereon.

In another aspect of the invention, the filter holder further includes a top retainer and a carrier from which the support tabs extend. The carrier is adapted to receive the top retainer, and the filter is sandwiched and held between the top retainer and the carrier.

In another aspect of the invention, the filter is affixed to the filter holder with a retaining ring.

In another aspect of the invention, the filter holder further includes a date indicator.

### BRIEF DESCRIPTION OF THE DRAWINGS

FIG. 1 is a schematic drawing, partly in section, of a filter assembly constructed in accordance with the prior art.

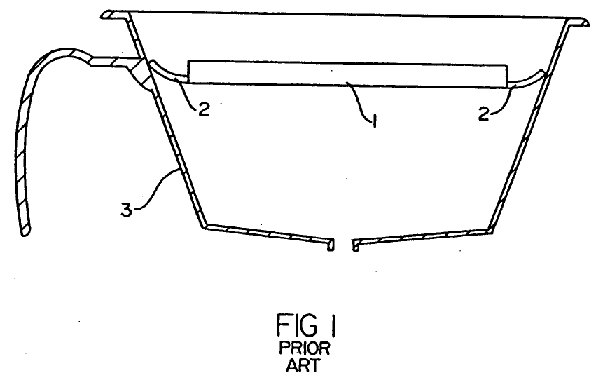

FIGS. 2a through 2c are perspective views of a first embodiment of the invention.

FIGS. 3a through 3d are perspective views of second and third embodiments of the invention.

FIGS. 4a through 4d are perspective views of a fourth embodiment of the invention.

FIG. 5a and 5b are, respectively, a top plan and a perspective view of a fifth embodiment of the invention.

### DETAILED DESCRIPTION OF THE PREFERRED EMBODIMENTS

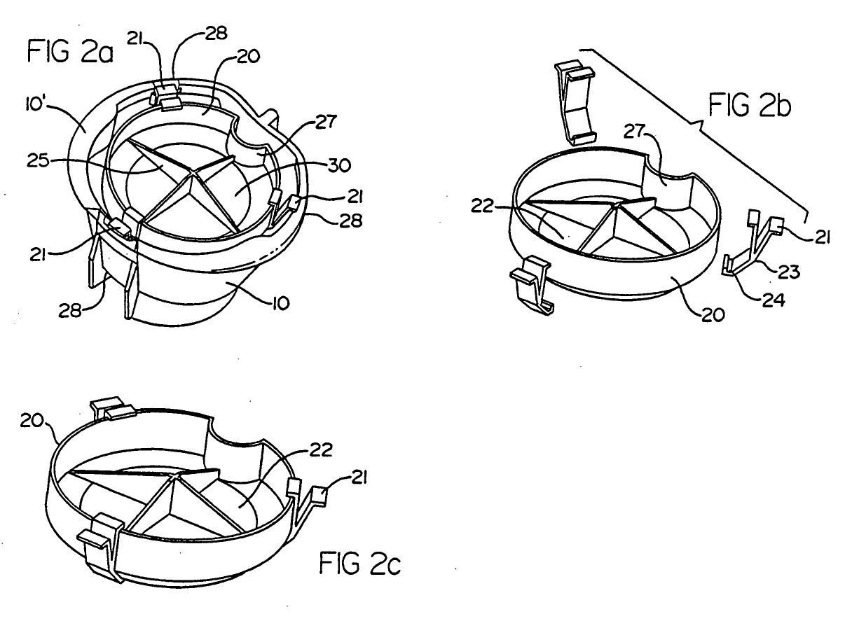

Referring to FIGS. 2a, 2b and 2c there is shown a preferred embodiment of the invention wherein a filter holder 20 is provided with a plurality of support tabs 21 that extend outwardly there from to engage the inner walls of a brew basket 10. The support tabs 21 support the filter holder 20 substantially flush with or below the upper rim 10′ of the brew basket 10 so as not to interfere with the insertion and removal of the brew basket into and out of a coffee maker. The purpose of the filter holder 20 is to hold and support a water filter. The filter holder 20 is preferably provided with a recess 27 to allow the filter holder to fit within certain brew baskets and to allow the user to easily grasp the filter holder 20 and remove it from the brew basket 10.

Referring to FIGS. 2b and 2c, there is shown a filter holder 20 with a filter 22 mounted thereon. The preferred filter 22 is a disk filter, meaning the thickness of the circular filter 22 is substantially smaller than the width or diameter of the filter. The filter 22 may be adhesively bonded, insert molded, ultrasonically welded or otherwise permanently attached to the filter holder 20. In this manner, the filter holder 20 and filter 20 may be replaced as a single unit.

A plurality of snap-on mounting units 23 are provided in the form of resilient Y-shaped fingers, each having a support tab 21 thereon. The snap-on units 23 are snapped on to the filter holder 21 such that a filter retaining portion 24 of the snap-on mounting units 23 engage the filter 22 and hold it in place. The snap-on mounting units are of sufficient thickness and strength so as to avoid loss of resiliency so as to demonstrate no substantial deformation during normal operating temperatures. Further, the support tabs 21 are under sufficiently minimal or no bending when the filter holder 20 is mounted within the brew basket 10 to avoid deformation during normal operating temperatures. The mounting unit 23 fit within the brew basket 10 with a clearance fit, except for tabs 21.

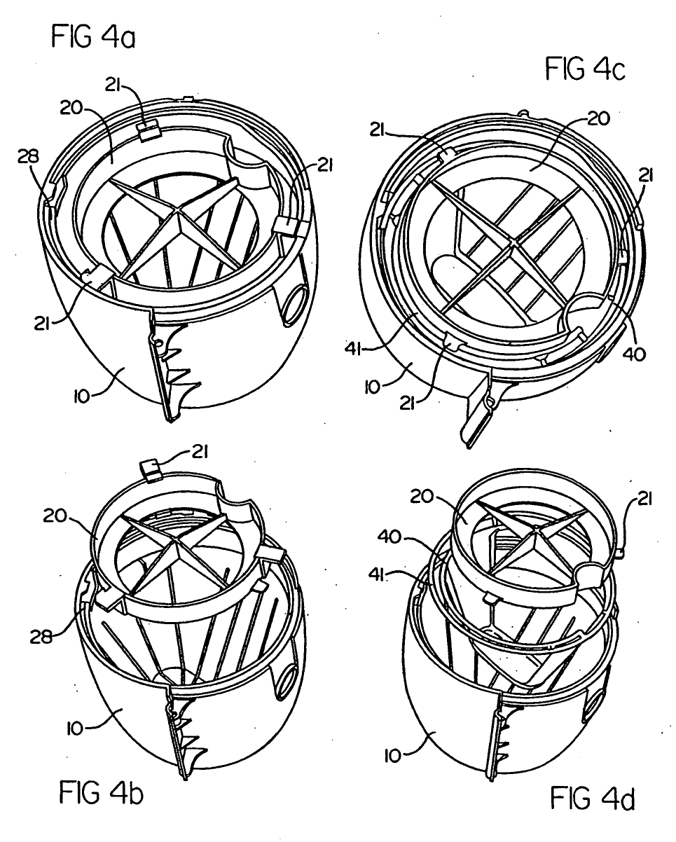

For many existing models of coffee makers, there will be sufficient vertical clearance between the upper rim 10′ of the brew basket 10 and the coffee maker to allow the support tabs 21 to sit or clamp upon the upper rim 10′ of the brew basket. For models with tighter tolerances, it may be necessary to modify the brew basket design to include one or more recessed pockets or tab receivers 28 in the brew basket so as to permit the upper surfaces of the support tabs 21 to sit flush with or below the upper rim 10′. The tab receivers 28 may be in the form of notches in the rim 10′ of the brew basket 10, or one or more vertically-recessed ledges on the inside wall of the brew basket 10, such as the depressed rim 28 shown in FIGS. 4a and 4b.

Filter 22 can take the form of a flexible disk having a filtering agent such as activated carbon particles sandwiched between two sheets of flexible porous textile material 30. An anti-flexing frame structure 25 (FIG. 2a) may be desirable to avoid tearing of the filter material. An annular plastic support ring 31 (FIG. 2b) may be molded around the circumferential edge of the filter 22 to provide additional support and rigidify to the filter 22.

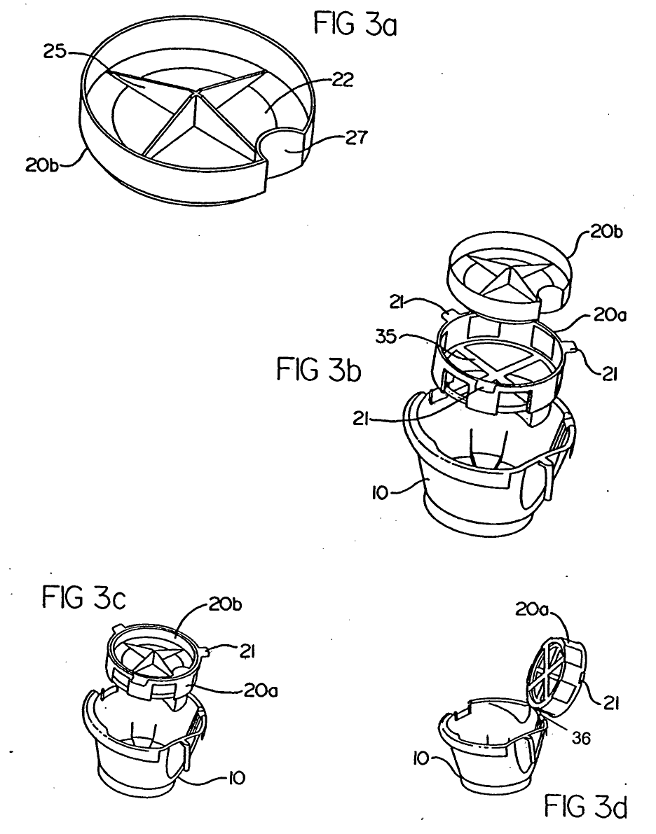

Referring to FIGS. 3a through 3c, there is shown a second embodiment of the invention wherein the filter holder 20 includes a carrier 20a and a top retainer 20b. The carrier 20a has an anti-flexing cross brace structure 35 for supporting flexible or rigid filters. The filter 22 maybe bonded or otherwise fixed to the top retainer 20b and is thereby held in place on the brew basket 10 by the top retainer 20b and the carrier 20a. One or more support tabs 21 are integrally molded around the carrier's periphery. The assembly of the carrier 20a, filter 22 and top retainer 20b is simply dropped into the brew basket 10 with a circumferential clearance fit (except for tabs 21) for easy mounting.

What is meant by “one or more” support tabs 21 is that a single support tab may support the filter if the single “tab” is formed as an annular ring or rim encircling the rim of the carrier. The single tab may extend more than 180 degrees around the rim of the carrier 20a.

Referring to FIG. 3d there is shown a third embodiment where the carrier 20a is hinged to the brew basket 10 about a horizontal axis and may simply be swung out of the way when emptying the brew basket 10 of used coffee grounds. The carrier 20a may be removably and replaceably snap fit to the brew basket 10 with a pair of resilient ball and socket hinges 36 of the type commonly used on hinged plastic boxes and the like. A piano type hinge may also be used.

As shown in FIGS. 4a through 4d, fourth and fifth embodiments of the invention mold the support tabs 21 integrally and homogeneously onto the filter holder 20. For purposes of clarity, neither the filter nor the means of securing it to the filter holder are shown.

In FIGS. 4a and 4b, the support tabs 21 are mounted high on the rim of the filter holder 20 and engage the brew basket 10 as described above with respect to the previous embodiments of FIGS. 2 and 3. Here the tab receiver 28 is shown as a depressed rim or stepped recessed ledge running around the inside wall of the brew basket 10.

In FIGS. 4c and 4d, the support tabs 21 are mounted lower on the rim of the filter holder and engage the upper rim of a filter basket 40 typically including a permanent metal or plastic filter screen. Such filter baskets 40 may have a bail or swing handle 41, so in such cases the diameter of the filter holder 20 will be chosen to fit within the diameter or opening defined by the swing handle 41.

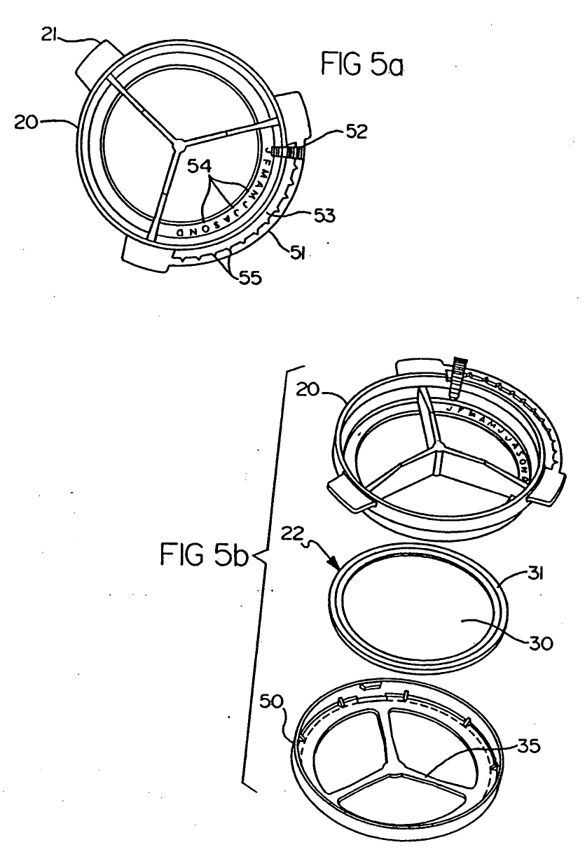

Referring to FIGS. 5a and 5b, there is shown a sixth embodiment of the invention wherein support tabs 21 are preferably integrally and homogeneously molded onto the filter holder 20. The filter 22 is held onto the filter holder 20 by a retaining ring 50 which attaches to the bottom of the filter holder 20, such as by screwing onto the bottom of the filter holder 20 or any other suitable interlocking means. The filter 22 is thereby sandwiched and clamped between the filter holder 20 and the retaining ring 50. The retaining ring 50 may be provided with a lower support structure such as cross braces 35 to retard flexing of the filter 22. This is also a means of retaining the filter for use with the embodiments of FIG. 4.

The filter holder may be provided with a date indicator 51, including a slide indicator 52, a notched slide groove 53, and date graduations 54 opposite the notches 55. The date graduations 54 will preferably indicate the twelve months of the year. When the user replaces the filter 21, the user slides the slide 52 to the proper notch to indicate either the current month or the month the filter 21 should be replaced. In this manner, the user is reminded when to change the filter 21. The slide indicator 52 is adapted to resiliently snap into and out of the notches 55.

One preferred material for making the filter holder 20, clip-on units 23, carrier 20a, and retaining ring is thermoplastic. Homopolymers are inexpensive and readily available thermoplastics, such as polyethylene and polypropylene. Polypropylene is preferred over polyethylene because of its greater resistance to deformation under conditions of heat and stress.

The preferred filter is a filtering agent, such as activated carbon, sandwiched between two porous sheets of material 30. A preferred disk filter 22 is thin, perhaps no more than a sixteenth to an eighth of an inch.

While various values, scalar and otherwise, may be disclosed herein, it is to be understood that these are not exact values, but rather to be interpreted as “about” such values, unless explicitly stated otherwise. Further, the use of a modifier such as “about” or “approximately” in this specification with respect to any value is not to imply that the absence of such a modifier with respect to another value indicated the latter to be exact.

Changes and modifications can be made by those skilled in the art to the embodiments as disclosed herein and such examples, illustrations, and theories are for explanatory purposes and are not intended to limit the scope of the claims. Further, the abstract of this disclosure is provided for the sole purpose of complying with the rules requiring an abstract so as to allow a searcher or other reader to quickly ascertain the subject matter of the disclosures contained herein and is submitted with the express understanding that it will. not be used to interpret or to limit the scope or the meaning of the claims.

1. A filter assembly for a brew basket, comprising:
a filter;
a filter holder adapted to hold the filter;
one or more support tabs extending outwardly from the periphery of said filter holder to an extent effective in engaging the brew basket to suspend said filter holder on the brew basket; and
wherein said one or more support tabs are of sufficient dimension and under substantially no bending stress when said filter holder is suspended in the brew basket so as to demonstrate no substantial deformation under normal heat conditions within the brew basket during use.

2. The apparatus of claim 1, wherein at least one of said support tabs is adapted to rest upon an upper rim of the brew basket.

3. The apparatus of claim 1, wherein at least one of said support tabs is adapted to engage a tab receiver provided on the brew basket.

4. The apparatus of claim 1, wherein said filter holder is hinged to the brew basket.

5. The apparatus of claim 1, wherein said filter is affixed to said filter holder by a plurality of snap-on units, each snap-on unit having one of said support tabs thereon.

6. The apparatus of claim 1, wherein said filter holder further comprises:
a top retainer;
a carrier from which said support tabs extend, said carrier adapted to receive said top retainer; and
wherein said filter is located between said top retainer and said carrier.

7. The apparatus of claim 1, wherein said filter is removably and replaceably mounted to said filter holder with a retaining ring.

8. The apparatus of claim 1, wherein said filter holder further comprises a date indicator.

9. A filter assembly for a brew basket, comprising:
a filter;
a filter holder adapted to hold said filter;
a brew basket adapted to support said filter holder;
one or more support tabs extending outwardly from said filter holder to suspend said filter holder on the brew basket; and
wherein said one or more support tabs are of sufficient dimension and under substantially no bending stress when said filter holder is suspended in the brew basket so as to demonstrate no substantial deformation under normal heat conditions within the brew basket during use.

10. The apparatus of claim 9, wherein said filter is affixed to said filter holder by a plurality of snap-on units, each snap-on unit having a support tab thereon.

11. The apparatus of claim 9, wherein said filter holder further comprises:
a top retainer;
a carrier from which said support tabs extend said carrier adapted to receive said top retainer; and
wherein said filter is removably mounted between said top retainer and said carrier.

12. The apparatus of claim 9, wherein said filter is affixed to said filter holder with a retaining ring.

13. The apparatus of claim 9, wherein said filter holder further comprises a date indicator.

14. The apparatus of claim 9, wherein said filter holder is hinged to said brew basket.

15. A water filter assembly, comprising:
a filter holder comprising a support member for supporting said filter holder within a brewing apparatus;
a brew basket supporting said filter holder; and
a substantially rigid tab projecting from said filter holder and supporting said filter holder on said brew basket.

16. The assembly of claim 15, wherein said brew basket has a recess formed therein, and wherein said tab is removably mountable in said recess.

17. The assembly of claim 15, wherein said filter holder is pivotally mounted on said brew basket.

18. The assembly of claim 17, wherein said filter holder is removably mounted on said brew basket.

19. The assembly of claim 15, further comprising a retainer ring removably mounted on said filter holder.

20. The assembly of claim 19, further comprising a filter removably held between said filter holder and said retainer ring.

21. The assembly of claim 19, wherein said retainer ring is mounted on said filter holder with a threaded connection.
